(19) United States
(12) Patent Application Publication
(10) Pub. No.: US 2025/0353557 A1
(43) Pub. Date: Nov. 20, 2025

(54) METHOD FOR ROBOT DAMAGE RECOVERY BASED ON MULTI-OBJECTIVE MAP-ELITES

(71) Applicant: South China University of Technology, Guangzhou (CN)

(72) Inventors: Yi Xiang, Guangzhou (CN); Shuning Xu, Guangzhou (CN); Han Huang, Guangzhou (CN); Jie Cao, Guangzhou (CN); Shuzhong Cui, Guangzhou (CN); Gang Li, Guangzhou (CN)

(21) Appl. No.: 18/988,972

(22) Filed: Dec. 20, 2024

(30) Foreign Application Priority Data
May 17, 2024 (CN) 202410612668.5

(51) Int. Cl. B62D 57/032; B25J 9/16

(52) U.S. Cl. CPC B62D 57/032; B25J 9/1653; B25J 9/1674

(57) ABSTRACT

Provided is a method for robot damage recovery based on multi-objective MAP-Elites, relating to the technical field of robot control. The method includes initializing a behavior map, and picking one parent controller parameter from the behavior map; employing a plurality of sample controller parameters to guide the direction of improvement, through gradient-based updates derived from performance feedback, and evolving the parental controller parameter into a child controller parameter; based on a dominance relationship, updating the parameters within the grids of the behavior map; initializing a damage recovery model using a map-based Bayesian optimization algorithm and the behavior map; adjusting and searching the damage recovery model to obtain an optimal controller parameter. Compared to existing technologies, this method enables the acquisition of controller parameters that enable robot damage recovery in a damaged environment without the need for interaction with a real environment, significantly reducing search time and effectively enhancing computational efficiency.

### CROSS REFERENCE TO RELATED APPLICATIONS

The present application claims the benefit of Chinese Patent Application No. 202410612668.5 filed on May 17, 2024, the contents of which are incorporated herein by reference in their entirety.

### TECHNICAL FIELD

The present disclosure relates to the technical field of robotic control, and in particular to a method for robot damage recovery based on multi-objective MAP-Elites.

### BACKGROUND OF THE INVENTION

In the field of reinforcement learning, the issue of robot damage recovery is a crucial research direction, particularly concerning how robots can autonomously repair and restore functionality after suffering damage or unexpected situations in a real-world environment. Damage recovery for multi-legged robots is a task that demands high flexibility and adaptability, requiring the robots after damage to identify damaged parts and promptly adjust their behavior strategies, such as modifying gait patterns, altering leg movements, and so on, to restore normal motor functions. In their paper titled “Scaling MAP-Elites to Deep Neuroevolution”, Cédric Colas, Joost Huizinga, et al. achieved remarkable results in the adaptive adjustment of quadruped ant robots after damage by utilizing a quality diversity algorithm based on a single-objective evolutionary strategy. Specifically, they first conducted preliminary training in an undamaged environment, using a single-objective function as the fitness function to evaluate the performance of candidate solutions in terms of the optimization objective, thereby guiding the search process efficiently. Subsequently, the robots underwent retraining in a damaged environment, where fine-tuning of the original model was performed to select the most suitable strategy from a pre-constructed grid for application in damaged scenarios, achieving superior performance. This approach demonstrated better performance compared to other similar algorithms.

In the conventional single-objective method, a plurality of potential performance indexes are simply combined into a single objective function, which overlooks the possible interdependencies and complex relationships among different objectives, thereby losing valuable information that may exist between them. Moreover, the single-objective method often limits the breadth of the search space, preventing the algorithm from fully exploring the rich potential solutions inherent in multi-objective problems. This limitation makes the algorithm prone to getting stuck in local optima, hindering the discovery of better global solutions.

Therefore, there is an urgent need to provide a method for robot damage recovery based on multi-objective MAP-Elites to better handle multi-objective optimization problems and improve the performance and adaptability of the algorithm.

### SUMMARY OF THE INVENTION

In view of the problems presented in the prior art, the present disclosure provides a method for robot damage recovery based on multi-objective MAP-Elite, which can better handle multi-objective optimization problems, fully consider different objectives, better explore the diversity in a solution space, avoid falling into local optima, and ultimately obtain solutions of higher quality.

The technical solution of the present disclosure is achieved as follows:
A method for robot damage recovery based on multi-objective MAP-Elites, the robot being a multi-legged robot, includes a behavior map construction phase and a damage adaptation phase, which respectively correspond to an undamaged environment and a damaged environment of the robot, wherein both the undamaged environment and the damaged environment are simulated environments, and there is at least one damaged environment;
the behavior map construction phase includes the following steps:
T1, initializing a behavior map, the behavior map including a plurality of grids, with at least one grid storing one controller parameter;
T2, picking one of the controller parameters from the behavior map as a parent controller parameter; obtaining a plurality of sample controller parameters by sampling around the parent controller parameter; interacting each of these sample controller parameters with the undamaged environment, respectively, and obtaining an evaluation result by evaluating the interaction, the evaluation result including a behavior characteristic, a distance fitness value, and a cost fitness value; obtaining gradient direction information by calculating an evolutionary gradient based on the evaluation result;
wherein, the ‘interaction’ specifically refers to controlling the robot to execute an episode in the simulated environment, which consists of a sequence of steps facilitated by application of the controller parameter;
T3, obtaining a child controller parameter by evolving the parent controller parameter according to the gradient direction information; obtaining an evaluation result by interacting the child controller parameters with the undamaged environment, and identifying an objective grid by locating the positions of the child controller parameter within the behavior map based on the behavior characteristics;
T4, comparing a dominance relationship between the child controller parameter and all the controller parameters within the objective grid according to the distance fitness value and the cost fitness value;
according to the dominance relationship, storing the child controller parameter to the objective grid, or replacing the controller parameter within the objective grid, or discarding the child controller parameter; and
T5, repeatedly executing steps T2 to T4 until a preset first iteration stop condition is reached;
the damage adaptation phase includes the following steps:
T6, selecting one damaged environment, initializing a damage recovery model using a map-based Bayesian optimization algorithm and the behavior map; obtaining an optimal controller parameter by adjusting and searching the damage recovery model; causing the multi-legged robot to recover in the damaged environment by using the optimal controller parameter; and
T7, repeating step T6 until all the damaged environments are simulated.

The behavior map construction phase corresponds to simulating the robot's undamaged environment, while the damage adaptation phase corresponds to simulating the damaged environment, i.e., the tested environment.

The distance fitness value is used to evaluate the distance traveled by the robot as it moves forward, such as the distance traveled forward in the x-axis direction after controlling the robot to perform an action. The cost fitness value is used to evaluate the cost incurred during movement, specifically the torque cost of each joint of the robot. For example, the cost fitness can be half of the sum of squares of a performed action vector, and the action vector typically includes the torques of all joints.

The behavior characteristic refers to a characteristic that describe an individual's behavior or performance, and is often used to measure effectiveness or performance of the individual in solving a problem or executing a task. Any indicator or attribute that helps define the individual's behavior or performance can be considered a behavior characteristic. MAP-Elites is a quality-diversity optimization framework in the field of evolutionary computation. Its core idea is to maintain a finite set of cells, each of which preserves the optimal individual in that region of a behavior space, also known as an elite individual, thereby achieving simultaneous optimization of the quality and diversity. MAP-Elites maps a simulated robot's “state-action” trajectory onto the behavior map in the environment by defining the behavior characteristic. Consequently, based on behavior characteristics, the individual possessing those characteristics can be located within a specific grid in the behavior map.

In T5, the first iteration stop condition can be that the number of iterations reaches a preset objective total number of times.

In this disclosure, the damage recovery refers to a capability of controlling the robot to maintain its forward-moving form, even if one or several of its joints are damaged, by utilizing a certain controller parameter. This allows the robot to continue moving forward even in the face of an unexpected damage.

By decomposing an original single objective into two fitness functions, it enables the simultaneous processing of two objectives, avoiding the algorithm from falling into the local optima and promoting the exploration of diversity in the solution space by a search algorithm, thus discovering a wider range of solutions. Ultimately, for a specific damaged environment, the most suitable optimal controller parameter is screened out from the behavior map as an optimal solution.

Compared to existing technologies, this solution does not require training a model based on different and real damaged environments to obtain a controller parameter that can control the robot to move forward in that specific damaged environment. Instead, it utilizes one single behavior map to construct an array of the controller parameters that can adapt to various damaged environments.

As a further optimization of the above solution, T1 includes the following specific steps:
T11, initializing the behavior space, which has a storage capacity to store Num controller parameters; converting the behavior space into the behavior map with the plurality of grids according to a preset discrete value Dis; and
T12, obtaining the controller parameters by randomly initializing a neural network model parameter based on a fully connected neural network; controlling the robot to interact with the undamaged environment by using the controller parameters and obtaining an evaluation result by evaluating the interaction; locating the controller parameters according to the behavior characteristic and storing them in the grid.

The behavior space refers to a space that describes individual characteristics. By discretizing the behavior space along various dimensions, the behavior map represented in a grid structure can be obtained, wherein each grid cell maintains one or more individuals with optimal performance in the current grid.

The Fully Connected Neural Network (FCN) is an artificial neural network structure that has a relatively simple connection way and belongs to a category of Feedforward Neural Networks (FNN). It is mainly composed of an input layer, a hidden layer, and an output layer, with a plurality of neurons possible in each hidden layer. The Fully Connected Neural Network possesses powerful characteristic extraction and learning capabilities, enabling their application to a wide range of tasks such as classification, regression, and unsupervised learning.

During each interaction process, a plurality of evaluations are conducted, and the final evaluation result is the mean of results of these evaluations.

As a further optimization of the above solution, in T11, a preset dimension value Dim is also included, wherein the behavior space is uniformly discretized into Dis parts along each dimension according to the discrete value Dis to obtain the behavior map whose number of the grids is Dis^{Dim}; the number of the controller parameters that each of the grids accommodates is

$$\frac{Num}{{Dis}^{Dim}} .$$

As a further optimization of the above solution, the behavior characteristic is represented by a multi-dimensional vector. Each dimension of this vector represents the proportion of time that a given foot of the robot is in contact with the ground during each episode of the steps, each dimension being in a value ranging from 0 to 1;
each of the grids corresponds to a unique first identifier, wherein the first identifier is a multi-dimensional array or a multi-dimensional vector and includes a plurality of index values; and
dimensions of the behavior map, the behavior characteristic, and the first identifier are the same; the locating process is performed by dividing the value range into a plurality of intervals according to the dimension, and mapping and converting each parameter of the behavior characteristic into the index value based on its sequential position according to the intervals, thereby obtaining the corresponding first identifier.

The simulated environment exposes its interfaces to the outside. By invoking the interfaces provided by the simulated environment, the contact information and the number of contact points from the current episode of steps within the simulation environment are acquired. Each contact point is traversed iteratively. If there is contact and it is between one of the legs of the multi-legged ant robot and the ground, the number of times the corresponding leg makes contact with the ground is added by 1. The time proportion of each leg being in contact with the ground can be calculated by dividing the number of times the leg makes contact with the ground by the current episode of steps.

As a further optimization of the above solution, T2 includes the following specific steps:
T21, in the behavior map, taking a sum of the distance fitness value and the cost fitness value as an equal-weight overall fitness value; selecting the grid where the controller parameter with the maximum equal-weight overall fitness value is located; or
for the most recent a grids where the controller parameters have been stored, ranking in a descending order based on the equal-weight overall fitness value, randomly selecting one of the top b grids, wherein a and b are both predefined integer values (i.e. custom values), and a≥b;
T22, randomly selecting one of the controller parameters from the selected grid as the parent controller parameter;
T23, constructing an isotropic multivariate Gaussian distribution based on the parent controller parameter, generating the plurality of sample controller parameters by randomly sampling in the multivariate Gaussian distribution;
T24, controlling the robot to interact with the undamaged environment using the sample controller parameters and obtaining the evaluation result by performing the evaluation; and
T25, assigning different weights to the distance fitness value and the cost fitness value of the sample controller parameter, respectively, calculating a weighted overall fitness value; obtaining the gradient direction information by performing gradient estimation on the weighted overall fitness value by using a stochastic gradient ascent method.

In T21, in response to determining that the number of recently stored data grids is less than a, only the previous method is used to select the grid; otherwise, one of the two methods is randomly chosen with a 50% probability for grid selection.

“The stochastic gradient ascent method” is an optimization algorithm that uses randomly selected samples to estimate a gradient and updates parameters in the direction of gradient ascent to maximize an objective function. “The gradient estimation” refers to approximate calculation of a gradient of a weighted overall fitness value relative to model parameters. The gradient is a vector that indicates the steepest direction of ascent for the function at each point.

Using the weighted fitness value to calculate the gradient guides a direction of evolution, allows for a more comprehensive consideration of relationships and trade-offs between different objectives, and can also enhances the diversity of the solution space explored by the search algorithm, thus avoiding the algorithm from getting trapped in local optimal.

As a further optimization of the above solution, the distance fitness value, the cost fitness value and the weighted overall fitness value are represented by D(θ), C(θ) and F(θ), respectively; the corresponding weights for the distance fitness value and the cost fitness value are ∝, and β, respectively;
in each iteration, the process of calculating the weighted overall fitness value is as follows:

$$∝ = ∝ - \frac{2 \times w - R}{N} ,$$

$$β = 1 - ∝ ,$$

$$F ( θ ) = ∝ D ( θ ) + β C ( θ ) ;$$

wherein, R is a weight range control parameter; w is a distance function initial weight, the weight range corresponding to the distance fitness value is [R-w, w]; N is the number of iterations, θ is the controller parameter.

As a further optimization of the above solution, in T4, the dominance relationship includes a completely dominating relationship, a completely dominated relationship, and a non-dominance relationship;
in response to determining that the child controller parameter outperforms one or more controller parameters within the objective grid in terms of both the distance fitness value and the cost fitness value, this situation is classified as the completely dominating relationship; in this case, all the controller parameters within the objective grid that are fully dominated by the child controller parameter are removed, and the child controller parameter is stored in the objective grid;
in response to determining that at least one controller parameter within the objective grid completely dominates the child controller parameter, it is considered as the completely dominated relationship, and the child controller parameter is discarded; and
in response to determining that the dominance relationship between the child controller parameter and the controller parameters within the objective grid is neither the completely dominating relationship nor the completely dominated relationship, it is considered as the non-dominance relationship; in this case, it is judged whether a storage space of the objective grid has reached the maximum capacity: if not, the child controller parameter is directly stored in the objective grid; otherwise, one controller parameter within the objective grid is randomly selected and replaced with the child controller parameter.

For a plurality of fitness values associated with two parameters A and B, in response to determining that all fitness values of A are better than all fitness values of B, then A completely dominates B; conversely, A is completely dominated by B; otherwise, A and B are in the non-dominance relationship.

By continuously updating the array of controller parameters stored in the grid based on the dominance relationship, the fitness values corresponding to this array of the controller parameters can form a Pareto front. That is, within the current grid, using this array of controller parameters can achieve an optimal first performance value while providing possibilities of the trade-offs and selections between the two objectives under different damaged environments.

As a further optimization of the above solution, each leg of the multi-legged robot includes at least two joints, which are in either a damaged or normal state;
in T6, for the controller parameter, a performance value is generated by adding a product of the distance fitness value with a custom weight and a product of the cost fitness value with another custom weight, wherein the performance values calculated for the controller parameter after interacting with the undamaged environment and the damaged environment are respectively a first performance value and a second performance value;

Specifically, the weights are used in both the performance values and the aforementioned weighted overall fitness values, but they are not the same. In the weighted overall fitness values, the weights are adaptively updated by the algorithm; whereas, in the performance values, the weights are customized by a user based on actual requirements.

T6 includes the following specific steps:
T61, setting an arbitrary number of the joints at arbitrary positions to the damaged state to simulate the damaged environment;
T62, in the behavior map, calculating the first performance values for all the controller parameters, wherein the controller parameter with the maximum first performance value is a first objective parameter;
constructing a Gaussian process (GP) model by adopting the map-based Bayesian optimization algorithm (M-BOA) and using the behavior characteristics and the first performance values of all the controller parameters from the behavior map., wherein the GP is used to predict the performance of the controller parameters; the Gaussian process model is structured as a dictionary: its keys are unique second identifiers corresponding one-to-one with the controller parameters within the behavior map; the value of the dictionary is a tuple composed of a mean μ and a variance σ2, wherein the mean signifiesanestimated performance of the controller parameter;
T63, constructing an acquisition function by utilizing the mean and variance; calculating a function value for the controller parameter using the acquisition function and selecting the controller parameter with the maximum function value as a second objective parameter;
T64, obtaining an evaluation result by interacting the second objective parameter with the damaged environment; updating the Gaussian process model by using the behavior characteristic and the second performance value of the second objective parameter;
T65, repeating steps T63 and T64 until a preset second iteration stop condition is met; and
T66, selecting the controller parameter with the maximum estimated performance as a third objective parameter; obtaining an evaluation result by interacting both the first objective parameter and the third objective parameter with the damaged environment, and selecting the one with the maximum second performance value as the optimal controller parameter.

In the map-based Bayesian optimization algorithm, the behavior characteristics and first performance values of all the controller parameters are used as a kind of prior knowledge to help the algorithm explore a parameter space more effectively. By combining the specific structure and characteristics of the map, the algorithm can more accurately predict the performance of the second performance value under different parameter configurations.

Gaussian Process (GP) is a type of stochastic process in probability theory and mathematical statistics, referring to a collection of random variables where any finite number of the random variables in this collection follow a joint normal distribution. In the Gaussian Process, any linear combination of the random variables follows a normal distribution, and every finite-dimensional distribution is the joint normal distribution, whose probability density function over a continuous index set is a Gaussian measure of all the random variables. The Gaussian Process is fully determined by its mathematical expectation and covariance function, and inherits many properties of the normal distribution.

T61 is used to simulate a specific damaged environment; and
in T65, the second iteration stop condition can be that the number of iterations reaches a preset objective total number of times.

By repeatedly executing T61 to T66 until all the damaged environments are simulated, the optimal controller parameters for each damaged environment can be selected. The optimal controller parameters enable the robot to walk forward with better performance while incurring lower costs in the damaged environment, also meaning that for a specific scenario or environment, the obtained controller parameters can allow the robot to walk forward a longer distance with the lower costs, or to walk forward as far as possible without consuming excessive costs.

In real environments, parameter training requires using the controller parameters to control the robot to completely execute the entire operation process, which involves traversing a plurality of the damaged environments and a plurality of the controller parameters, leading to significant time consumption. In this solution, by simulating the process and updating the Gaussian process model, it is possible to predict the estimated performance corresponding to each controller parameter. Although traversing is still necessary, it is only used to calculate correlations between the behavior characteristics, thereby updating the Gaussian process model. This eliminates the need to test all the controller parameters in the environment one by one, resulting in significantly shorter time consumption compared to traversing all the controller parameters in a single damaged environment.

While it is possible to directly select the first objective parameter as the optimal controller parameter, this approach may yield inferior results. A more effective method might involve a careful comparison of the first and the third objective parameter, leading to the selection of the third objective parameter as the optimal one. However, the direct selection method has the advantage of saving computation time for the third objective parameter, essentially trading off quality for time.

As a further optimization of the above solution, in T61, an updated container is also constructed;
in T63, the second objective parameter is also stored in the updated container;
in T62, mean and variance initialization is performed for all the controller parameters within the behavior map;
wherein, the first performance value of each controller parameter is normalized, the first performance value is converted to a decimal value within the range of [0,1], which serves as an initial value of the mean;
an initial value of the variance is calculated as:

$${σ}_{i}^{2} = M ( {BC}_{i} , {BC}_{i} ) ;$$

wherein, i is the second identifier, representing the i-th controller parameter within the behavior map; BCᵢ represents the behavior characteristic of the i-th controller parameter; M(x,y) is a kernel function, and the construction formula of the kernel function is:

$$M ( x , y ) = ( 1 + \frac{\sqrt{5} d}{v} + \frac{5 {d}^{2}}{3 {v}^{2}} ) \times exp ( - \frac{\sqrt{5} d}{v} ) ;$$

wherein, x and y represent two behavior characteristics, d represents an Euclidean distance between x and y, and v is a preset length scale parameter;

$$exp ( - \frac{\sqrt{5} d}{v} )$$

is an exponential function, representing e raised to the power of

$$- \frac{\sqrt{5} d}{v} ;$$

the kernel function is used to calculate the correlation between two behavior characteristics;
in T64, all the means and variances of the Gaussian process model are updated;
wherein, the process for updating the means is as follows:
T641, constructing a performance difference vector P_{diff}; for all the second objective parameters in the updated container, calculating a difference of the first performance value and second performance value of each second objective parameter, and storing the difference into the performance difference vector;
T642, for all the second objective parameters within the updated container, calculating the correlation between the behavior characteristics of any two controller parameters by adopting the kernel function, and obtaining a covariance matrix K after adding Gaussian white noise with a variance of 0.01;

T643, for all the controller parameters within the behavior map, obtaining a covariance matrix k by adopting the kernel function to calculate the correlation of the behavior characteristics between all the control parameters within the behavior map and all the second objective parameters within the updated container;

T644, in the Gaussian process model, the mean is calculated as

$${μ}_{i} = {p}_{undamaged \_ i} + {k}^{T} \cdot ( {K}^{- 1} \cdot {P}_{diff} ) ;$$

wherein, P_{undamaged_i} represents the first performance value of the i-th controller parameter;
the process for updating the variance is as follows:
T645, the updating calculation of the variance corresponding to the i-th controller parameter is as follows:

$${σ}_{i}^{2} = M ( {BC}_{i} , {BC}_{i} ) - {k}^{T} \cdot {K}^{- 1} \cdot k ;$$

that is, an autocorrelation metric of the behavior characteristic BCᵢ minus the dot product of the covariance matrices.

The kernel function used in this solution is a Matérn kernel function, which is used to calculate a similarity between two points and further utilized to establish a covariance matrix. This covariance matrix represents the correlations of the performance values among all input behavior characteristics.

The correlation metric assists the model in understanding how the new behavior characteristic estimates the performance value based on the correlation with known point pairs (BC, P). By establishing the correlations, the Gaussian process model can leverage existing data pairs (BC, P) to make informed predictions for unknown data pairs (BC, P), i.e., predicting the performance values corresponding to the behavior characteristics of the controller parameters that have not been tested in the damaged environment based on the performance values corresponding to the behavior characteristics of the controller parameters that have already been tested in the damaged environment. Compared to completely traversing the interactions between all the controller parameters and the damaged environment in the behavior map, using the Gaussian process model to predict an interaction result offers high prediction accuracy and quality while significantly reducing the time required to obtain the objective parameters, thereby enhancing efficiency.

In the initialization of variance, the kernel function is used to obtain the autocorrelation metric for the behavior characteristic itself, indicating that predictive variability of this point is not influenced by other points.

Furthermore, the value of v is 2.5. As a further optimization of the above solution, the acquisition function is expressed as:

$${UCB}_{i} = {μ}_{i} + κ {σ}_{i}^{2} ;$$

wherein K is an exploration parameter, and i is the second identifier.

UCB stands for Upper Confidence Bound, which is an algorithm based on the concept of confidence intervals (i.e. confidence interval algorithm). Wherein, K refers to the Greek letter kappa and is not the same parameter as the covariance matrix k mentioned previously.

Compared with the prior art, the present disclosure achieves the following beneficial effects:

(1) During the evolution phase, the present disclosure decomposes the original single objective into two distinct fitness functions to facilitate the concurrent optimization of dual objectives. This approach prevents premature convergence to local optima, enhances the algorithm's exploration of the solution space to embrace diversity, and uncovers a broader spectrum of potential solutions.

(2) Depending on the iterations, the disclosure automatically adjusts the weight distribution among fitness functions across various iterations. It conducts these adjustments based on a predefined set of rules and performance indicators, eliminating the requirement for manual calibration of weight coefficients for each objective. Through its adaptive weight adjustment mechanism, the algorithm can probe a wider array of potential solutions, enrich the diversity of evolution, and more adeptly navigate the trade-offs inherent among conflicting objectives as the optimization progresses.

(3) In the multi-objective model developed, the MAP-Elites algorithm serves as the foundation for constructing a behavior map, wherein each grid contains a Pareto front representing a set of optimal trade-off solutions. The evolution of these Pareto fronts ensures both the diversity and quality of the solutions are maintained. For the specific damaged environment, the optimal controller parameter is meticulously selected from the behavior map, ensuring it align closely with the specific requirements of the scenario. Depending on the unique conditions of the damaged environment, the selection process prioritises user needs to find the solution that best balance the trade-offs between the objectives.

(4) Unlike conventional methods that often require direct training within various specific real-world damaged environments to derive the optimal controller parameters for robot mobility, this approach employs a behavior map constructed via extensive simulation of potential damages. This map effectively circumvents the need for direct environment-specific training by offering a comprehensive array of the controller parameters. These parameters are pre-calculated to accommodate a wide spectrum of damaged scenarios. Consequently, this approach can adaptively select the most fitting controller parameters for any given damaged environment encountered, leveraging the behavior map as a versatile, pre-optimized resource.

(5) By leveraging the Gaussian process model, the performance of different controller parameters in the damaged environments can be intelligently predicted. This approach allows us to efficiently approximate the optimal controller parameters without the need to exhaustively simulate each parameter's interaction with the environment. By utilizing predictive modeling, it significantly accelerates the optimization process, enhancing the efficiency of identifying the most effective controller parameters. This method not only streamlines the search process but also ensures robust adaptability by closely approximating the best parameters with minimal exploration.

(6) In the context of evolutionary algorithms applied to robotic tasks, the objectives can greatly vary. For cost-oriented tasks, the algorithm prioritizes the minimization of expenditure, adjusting its selection and optimization processes to evolve solutions that yield higher economic benefits with lower costs. In contrast, for effect-oriented tasks, the algorithm focuses on maximizing performance metrics, such as the distance a robot can travel forward. This involves adjusting the fitness functions to reward forward in task performance more heavily than cost efficiency. Depending on the task's specific requirements, evolutionary strategies can be fine-tuned to balance between extending the maximum possible distance with minimal cost and achieving substantial progress without significant cost concerns through multi-objective optimization frameworks. This flexible approach allows for the dynamic adaptation of robotic behaviors to meet varying objectives efficiently.

### BRIEF DESCRIPTION OF DRAWINGS

FIG. 1 is an interaction diagram of a method for damage recovery provided in an embodiment of the present disclosure;

FIG. 2 is a flow diagram of the method for damage recovery in a behavior map construction phase provided in the embodiment of the present disclosure; and

FIG. 3 is a flow diagram of the method for damage recovery in a behavior damage adaptation phase provided in the embodiment of the present disclosure.

### DETAILED DESCRIPTION OF THE INVENTION

In order to make objects, technical solutions and advantages of the present disclosure more clear, the technical solutions in embodiments of the present disclosure will be clearly and completely described below in conjunction with the accompanying drawings in the embodiments of the present disclosure, it is obvious that the described embodiments are only a part of the embodiments of the present disclosure, but not all of the embodiments. Based on the embodiments in the present disclosure, all other embodiments obtained by those of ordinary skill in the art without making inventive labor belong to the scope of protection of the present disclosure.

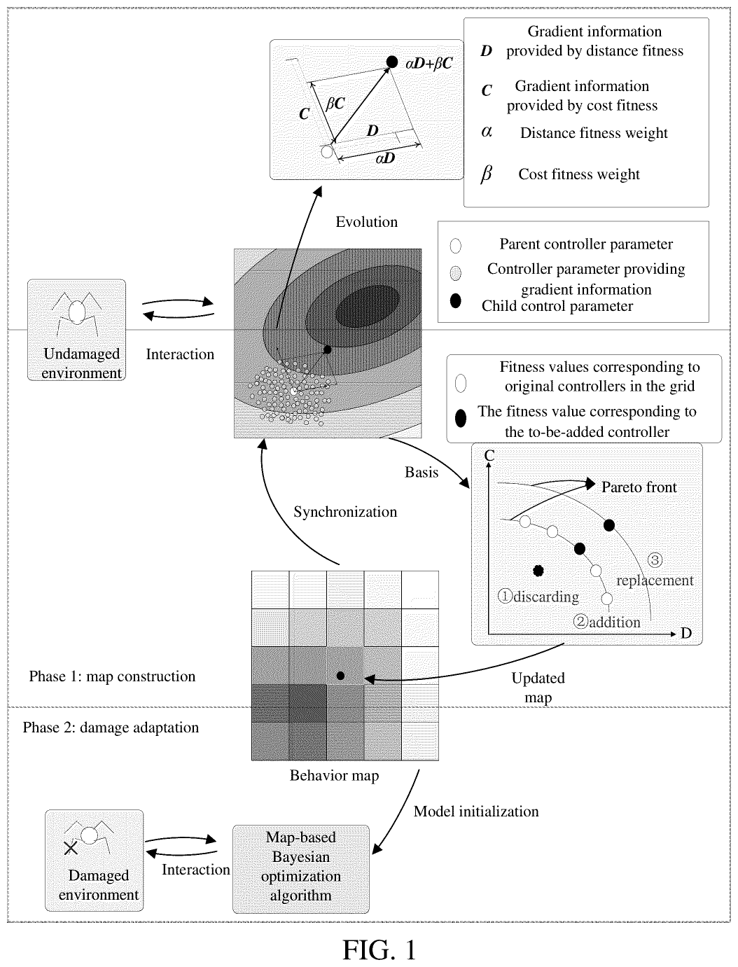

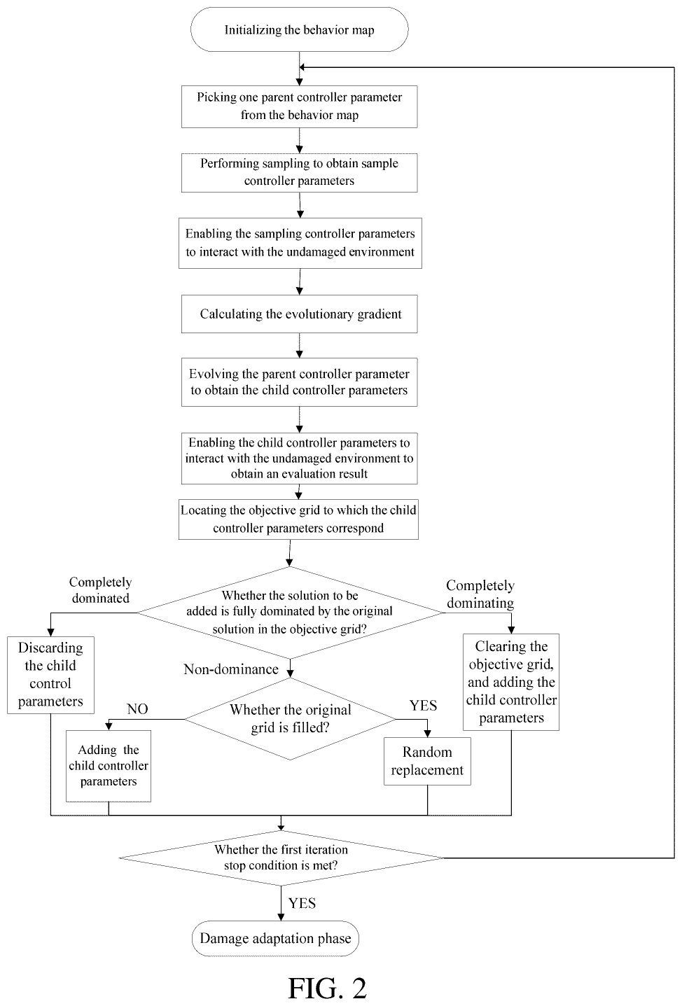

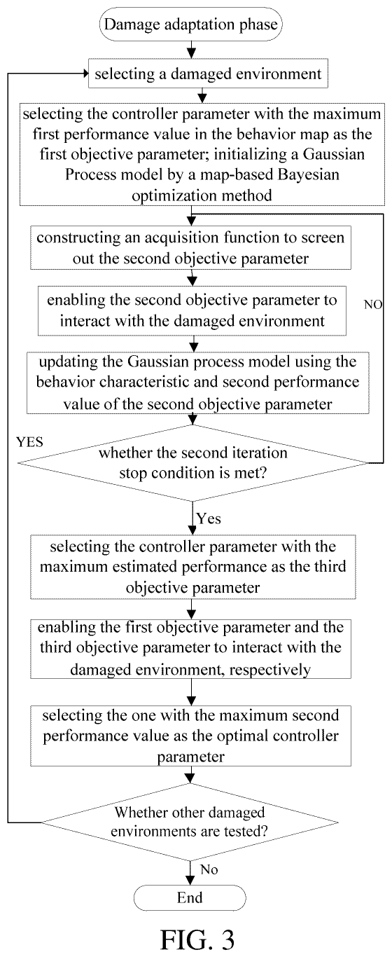

As shown in FIGS. 1 to 3, this embodiment provides a method for robot damage recovery based on multi-objective MAP-Elites, the robot is a quadruped ant robot with each leg consisting of two joints, and the joints can be in either a damaged or normal state. The method includes a behavior map construction phase and a damage adaptation phase, which respectively correspond to an undamaged environment and a damaged environment of the robot. Both the undamaged environment and the damaged environment are simulated environments. In this embodiment, effectiveness of system is tested using a Mujoco Ant-v2 simulated environment. Mujoco Ant-v2 is a task within one simulated environment, specifically referring to a second version of an Ant robot model simulated in a MuJoCo (a multi-joint dynamics and motion engine) physics engine. The Ant-v2 model is the quadruped robot, whose goal is typically to walk stably or perform specific tasks in different terrains and environments.

The behavior map construction phase includes the following steps:
T1, a behavior map is initialized, the specific steps include:
T11, a behavior space is initialized, which has a storage capacity to store Num controller parameters; the behavior space is uniformly discretized into Dis parts along each dimension according to a predetermined discrete value Dis and a predetermined dimension value Dim, resulting in the behavior map whose number of grids is Dis^{Dim}; the number of controller parameters that each of the grids accommodates is

$$\frac{Num}{{Dis}^{Dim}} .$$

Each of the grids corresponds to a unique first identifier, wherein the first identifier is a multi-dimensional array or a multi-dimensional vector and includes a plurality of index values.

Given the original settings of the simulated environment, under the condition that the total storage capacity of the behavior space remains constant at 10⁴ controller parameters, the behavior space is uniformly discretized into 5 parts along each dimension according to the specified discrete value of 5, resulting in a behavior map of 5×5×5×5. Consequently, the behavior map includes 625 grids in total, with each grid capable of accommodating a maximum of 16 parameters.

A one-dimensional array, ranging from 0 to 624 with a step size of 1, is initialized to serve as a set of unique identifiers. These identifiers are then mapped to a 4-dimensional behavior space, ensuring that each grid in the behavior map is assigned a unique first identifier. This mapping facilitates the rapid localization of specific grids based on their 4-dimensional coordinates by establishing a direct correspondence between the one-dimensional identifiers and the cells' positions within the four-dimensional space. The arrangement within this higher-dimensional space is methodically designed so that the unique identifier of each grid can be efficiently computed or decoded from its coordinates, allowing for immediate access to any grid in the behavior map.

T12, neural network model parameters are randomly initialized based on a fully connected neural network to obtain the controller parameters; the robot is controlled to interact with the undamaged environment by using the controller parameters and the interaction is evaluated to obtain an evaluation result; the controller parameters are classified and assigned to specific grid within the behavior map according a behavior characteristic.

The fully connected neural network with two hidden layers is used as a controller, wherein each hidden layer includes 256 neurons, neural network model parameters are randomly initialized through Xavier initialization. The initialized controller parameters are then employed to guide the actions of quadruped ant robot for a single episode within the simulated environment. At the end of each episode, the agent undergoes 30 evaluations to assess its performance. The results of these evaluations are then averaged to obtain behavior characteristic, the total distance traveled forward by the robot as well as the total sum of torque costs incurred by each joint.

In this embodiment, the behavior characteristic of the robot is defined as a multi-dimensional vector, where each dimension reflects the proportion of time each foot is in contact with the ground throughout an episode. Specifically, each dimension ranges from 0 to 1, with 0 indicating no ground contact and 1 representing continuous ground contact during the episode; and
the dimensions of the behavior map, the behavior characteristic, and the first identifier are the same; the locating process is performed by dividing the value range into a plurality of intervals according to the dimension, and mapping and converting each parameter of the behavior characteristic into the index value in sequence according to the intervals, thereby obtaining the corresponding first identifier.

Based on the behavior characteristic, the locations of the initialized controller parameters within the behavior map can be determined. Taking the behavior characteristic [0.1, 0.3, 0.3, 0.9] as an example. When dividing the range [0,1] into 5 equal segments, the value 0.1 falls within first segment, ranging from [0, 0.2), and is therefore associated with the index position 0. Similarly, 0.3 falls within the range of the second segment [0.2, 0.4), corresponding to the index positions 1, and 0.9 falls within the fifth segment [0.8,1], corresponding to the index position of 4. In this case, the tuple (0, 1, 1, 4) uniquely identifies a cell in the behavior map. Once the grid identifier is acquired, the controller parameters can be mapped to the behavior map grid associated with that identifier.

The behavior space refers to a multidimensional space that encompasses the range of possible actions or behaviors the agent can exhibit and representing the individual characteristics of actions or behaviors. By discretizing the behavior space into finite, quantifiable segments along each dimension, the behavior map represented in a grid structure can be obtained. The grid organizes the search space where each cell within the grid represents a discrete region of the behavior space, and it holds the date pertaining to one or more individuals that have demonstrated optimal performance within that particular region. This allows for a systematic exploration and exploitation of the behavior space, enabling the identification and optimization of behavior characteristics that lead to improved performance in reinforcement learning tasks.

The Fully Connected Neural Network (FCN) is a artificial neural network structure that has a relatively simple connection way and belongs to the category of feedforward neural networks. It is mainly composed of an input layer, a hidden layer, and an output layer, with a plurality of neurons possible in each hidden layer. The Fully Connected Neural Network possesses powerful characteristic extraction and learning capabilities, enabling their application to a wide range of tasks such as classification, regression, and unsupervised learning. In the context of reinforcement learning, FCNs can be employed as function approximators within the agent's architecture. Here, they serve to approximate the value function or policy function, facilitating the agent's decision-making process in complex environments by learning to predict the potential rewards of actions given the current state. This adaptation enables the reinforcement learning algorithms to tackle problems with high-dimensional input spaces, making FCNs an integral component of many state-of-the-art reinforcement learning solutions.

In each interaction phase with the environment, the agent performs multiple assessments to refine its policy and fitness function estimate. The final estimate is derived by appropriately aggregating the outcomes of these assessments, employing an averaging method to effectively incorporate the insights gained and mitigate the impact of variability or noise that is inherent in the process.

In the simulation, environments expose their APIs which allow for querying contacting formation and the count of contact points during the current episode. Each contact point is iteratively examined to determine if there is contact between any of the quadruped ant robot's legs and the ground. For every such contact detected, an internal counter for the corresponding leg's ground contact incidents is incremented. The proportion of time that each leg spends in contact with the ground is then calculated as the number of ground contacts made by the leg divided by the total number of steps in the current episode.

T2, one of the controller parameters is picked from the behavior map as a parent controller parameter; sampling around the parent controller parameter is performed to obtain a plurality of sample controller parameters; each of these sample controller parameters is then individually tested within the undamaged environment, leading to a set of evaluation results that encompass the behavior characteristic, a distance fitness value, and a cost fitness value; utilizing these evaluation metrics, an evolutionary gradient is derived to provide guidance on the direction for parameter optimization, aiming to enhance the controller's effectiveness;
wherein, the “interaction” specifically denotes the process whereby the robot is maneuvered through a sequence of steps within the simulated environment, governed by the set of controller parameters under evaluation. Throughout the course of an episode, these parameters determine the robot's actions, thereby providing a concrete basis for assessing their efficacy in navigation the simulated environment successfully;

In the present embodiment, T2 includes the following specific steps:
T21, in the behavior map, an equal-weight overall fitness value is calculated by summing the distance fitness value and the cost fitness value, each contributing equally to the overall fitness value; the grid that houses the controller parameters yielding the highest overall fitness value, as determined by this equal-weight summation, is then selected; or
for the most recent a grids storing the controller parameters, these grids are sorted in a descending order on their equal-weight overall fitness value. From those, one grid is randomly selected from among the top b ranked grids, wherein a and b are predefined integer values, and a≥b;

In the behavior map, the grid selection strategy hinges on the total number of grids filled with controller parameters. If this number is less than 5, the selection process selects the grid containing the controller parameter with the maximum equal-weight overall fitness value. However, when the total number of filled grids is greater than or equal to 5, the selection process follows a probabilistic approach:
There is a 50% chance that the system will choose the grid with the controller parameter exhibiting the maximum equal-weight overall fitness value; or
Alternatively, there is a 50% chance of randomly selecting one grid from the top two ranked grids. This selection is made from the 5 most recently filled grids, which are ordered in a descending order of their equal-weight overall fitness values. This method ensures a balance between selecting the best-performing grid and introducing variability into the selection process.
T22, one of the controller parameters is randomly selected from the selected grid as the parent controller parameter;
T23, an isotropic multivariate Gaussian distribution is constructed based on the parent controller parameter, random sampling is performed in the multivariate Gaussian distribution to generate the plurality of sample controller parameters;
T24, the robot is controlled to interact with the undamaged environment using the sample controller parameters and evaluation is performed to obtain the evaluation result; and
T25, different weights are assigned to the distance fitness value and the cost fitness value of the corresponding sample controller parameters, respectively, a weighted overall fitness value is calculated; gradient estimation is performed on the weighted overall fitness value by using a stochastic gradient ascent method to obtain the gradient direction information.

In this embodiment, the distance fitness value, the cost fitness value and the weighted overall fitness value are represented by D(θ), C(θ) and F(θ), respectively; the corresponding weights for the distance fitness value and the cost fitness value are ∝, and β, respectively;
in each iteration, the process of calculating the weighted overall fitness value is as follows:

$$∝ = ∝ - \frac{2 \times w - R}{N} ,$$

$$β = 1 - ∝ ,$$

$$F ( θ ) = ∝ D ( θ ) + β C ( θ ) ;$$

wherein, R is a weight range control parameter; w is a distance function initial weight, the weight range corresponding to the distance fitness value is [R-w, w]; N is the number of iterations, θ is the controller parameter.

In practical applications, the two weight parameters can be scaled to varying degrees depending on different problems. This is because after calculating fitness values, a rank normalization process is applied to replace the original fitness values with ranking positions, eliminating the impact of the absolute magnitude of fitness values on an evolutionary strategy. This transformation renders the fitness value more comparative, ensuring that an individual's fitness accurately mirrors its relative standing within the population. However, if the values of fitness components are exceedingly large, while the weight settings are confined to the range of [0,1], the weighted fitness values might struggle to substantially affect the final ranking of fitness values. Therefore, to enable the adjustment of weighted values to effectively impact the ranking of fitness values and generate more diverse variations in the evolutionary process, it is essential to scale the weight values either up or down, depending on the magnitude of fitness values inherent to the specific problems. In the problem addressed by this disclosure, the weight parameters are all scaled up by hundreds of times.

“The stochastic gradient ascent method” is an optimization algorithm that uses randomly selected samples to estimate a gradient and updates parameters in the direction of gradient ascent to maximize an objective function. “The gradient estimation” refers to the approximate calculation of the gradient of the weighted overall fitness value relative to model parameters. The gradient is a vector that indicates the steepest direction of ascent for a function at each point.

Using the weighted fitness value to calculate the gradient in evolutionary computation provides a strategic direction for the evolutionary process. This approach not only achieves a comprehensive consideration of relationships and trade-offs between different objectives but also increase a diversity of the solution space explored by a search algorithm. Consequently, it reduces the likelihood of the search algorithm getting trapped in local optima, promoting a more exploration of potential solutions.

T3, an Adam optimizer, with a learning rate set to 0.01 and an 12 regularization coefficient of 0.005, is used to evolve the parent controller parameter to obtain the child controller parameter according to the gradient direction information; the child controller parameter is interacted with the undamaged environment to obtain an evaluation result, the position of the child controller parameter within the behavior map is located based on the behavior characteristic to identity a specific objective grid;
T4, a dominance relationship between all the controller parameters within the objective grid and the child controller parameter is compared according to the distance fitness value and the cost fitness value;
according to the dominance relationship, the child controller parameter is stored to the objective grid, or the controller parameter within the objective grid is replaced, or the child controller parameter is discarded; and in the problem addressed by this disclosure, there exists a competitive relationship between two objectives, an improvement in one objective inevitably leads to a deterioration in the other, making it impossible to optimize both objectives simultaneously. Therefore, instead of maintaining a single optimal controller parameter in each discrete grid of the behavior map, an array of representative optimal controller parameters are maintained. Based on the fitness values of the controller parameters within the grid, a Pareto front P(Q)(θ₁, θ₂, . . . , θₘ∈Q) is formed, wherein Q represents the array of controller parameters stored in the grid. According to the calculation of T11, one grid can store up to 16 controller parameters, i.e., m=16.
the dominance relationship includes a completely dominating relationship, a completely dominated relationship, and a non-dominance relationship;
in response to determining that the child controller parameter outperforms all the controller parameters within the objective grid in both the distance fitness value and the cost fitness value, which means that the child controller parameter θ_{new} to be added exhibits superior performance in the simulated environment when controlling the quadruped ant robot compared to any quadruped antrobot controlled by an existing controller parameter, this is equivalent to ∀θ∈Q, D(θ_{new})>D(θ)&C(θ_{new})>C(θ), it is considered as the completely dominating relationship; in this case, the fully dominated controller parameters are removed, and the child controller parameter is stored in the corresponding objective grid;
in response to determining that at least one controller parameter within the objective grid completely dominates the child controller parameter, this is equivalent to ∃θ∈Q, D(θ_{new})<D(θ)&C(θ_{new})<C(θ), it is considered as the completely dominated relationship, and the child controller parameter is discarded; and
in response to determining that the dominance relationship between the child controller parameter and the controller parameters within the objective grid is neither the completely dominating relationship nor the completely dominated relationship, this is equivalent to ∃θ∈Q, D(θ_{new})<D(θ)&C(θ_{new})>C(θ), or D(θ_{new})>D(θ)&C(θ_{new})<C(θ), it is considered as the non-dominance relationship; in this case, it is judged whether a storage space of the objective grid has reached the maximum capacity: if not, the child controller parameter is directly stored in the objective grid; otherwise, one controller parameter within the objective grid is randomly selected and replaced with the child controller parameter.

For a plurality of the fitness values associated with two parameters A and B, in response to determining that all the fitness values of A are better than all the fitness values of B, then A completely dominates B; conversely, A is completely dominated by B; otherwise, A and B are in the non-dominance relationship.

By continuously updating the array of controller parameters stored in the grid based on the dominance relationship, the fitness values corresponding to this array of the controller parameters can form one Pareto front. That is, within the current grid, using this array of the controller parameters can achieve an optimal first performance value while providing possibilities of trade-offs and selections between the two objectives under different damaged environments.

T5, steps T2 to T4 are executed repeatedly until a preset first iteration stop condition is reached; the first iteration stop condition is that the number of iterations reaches a preset total objective number of times.

The damage adaptation phase includes the following steps:
T6, one of the damaged environments is selected, a damage recovery model is initialized using a map-based Bayesian optimization algorithm and the behavior map; the damage recovery model is adjusted and searched to obtain an optimal controller parameter; the multi-legged robot is enabled to recover in the chosen damaged environment by using the optimal controller parameter; and
for the controller parameter, a performance value is obtained by adding a product of the distance fitness value with a custom weight and a product of the cost fitness value with another custom weight; wherein the performance values calculated for the controller parameter after interacting with the undamaged environment and the damaged environment are respectively a first performance value and a second performance value. It should be noted that the weights used in the calculation of the performance values and the weighted overall fitness value are not identical parameters, but apart from the specific values of these weights, the calculation method for the performance value follows the calculation for the weighted overall fitness value.

T6 includes the following specific steps:
T61, an arbitrary number of the joints at arbitrary positions are set to a damaged state to simulate the damaged environment; an updated container is also constructed, which holds parameters selected for further analysis or implementation in the subsequent evolution stages;
T62, in the behavior map, the first performance values are calculated for all the controller parameters, wherein the controller parameter with the maximum first performance value is a first objective parameter;
the map-based Bayesian optimization algorithm is adopted, the behavior characteristics and the first performance values of all the controller parameters in the behavior map are used to construct a Gaussian process model; mean and variance initialization is performed for all the controller parameters within the behavior map;
wherein, the first performance value of each controller parameter is normalized, the first performance value is converted to a decimal value within the range of [0,1], which serves as an initial value of a mean;
an initial value of a variance is calculated as:

$${σ}_{i}^{2} = M ( {BC}_{i} , {BC}_{i} ) ;$$

wherein, i is a second identifier, representing the i-th controller parameter within the behavior map; BCᵢ represents the behavior characteristic of the i-th controller parameter; M(x,y) is a kernel function, and the construction formula of the kernel function is:

$$M ( x , y ) = ( 1 + \frac{\sqrt{5} d}{v} + \frac{5 {d}^{2}}{3 {v}^{2}} ) \times exp ( - \frac{\sqrt{5} d}{v} ) ;$$

wherein, x and y represent two behavior characteristics, d represents an Euclidean distance between x and y, and v is a preset length scale parameter, whose value is 2.5;

$$exp ( - \frac{\sqrt{5} d}{v} )$$

is an exponential function, representing e raised to the power of

$$- \frac{\sqrt{5} d}{v} ;$$

the kernel function is used to calculate a correlation between two behavior characteristics;
the Gaussian process model is used to predict the performance of the controller parameters; the structure of the model is conceptualized as a dictionary, and keys of the dictionary are the second identifiers corresponding one-to-one with the controller parameters within the behavior map; the value associated with each key is a tuple consisting of the mean μ and the variance σ², wherein the mean represents an estimated performance of the controller parameter, providing an indication of its expected efficacy, while the variance reflects the model's uncertainty regarding this estimate;
T63, an acquisition function is constructed by using the mean and variance. the acquisition function is expressed as:

$$U C {B}_{i} = {μ}_{i} + κ {σ}_{i}^{2} ;$$

wherein κ is an exploration parameter, and i is the second identifier.

UCB stands for Upper Confidence Bound, which is an algorithm based on the concept of confidence intervals (i.e. confidence interval algorithm). It employs the confidence intervals to optimize the overall performance, taking into account both the average estimated rewards and the uncertainty or variance associated with those estimates.

The acquisition function evaluates the efficiency of different controller parameters, determining their potential impact on the optimization goal; the controller parameter that achieves the highest value from the acquisition function is then identified as the optimal candidate and is designated as a second target parameter; and the second target parameter is stored in the updated container.

T64, the second objective parameter is interacted with the damaged environment to obtain an evaluation result; the behavior characteristics and the second performance value of the second objective parameter are used to update the Gaussian process model;
wherein, the process for updating the means is as follows:
T641, a performance difference vector P_{diff} is constructed; for all the second objective parameters in the updated container, a difference of the first performance value and second performance value of each second objective parameter is calculated, and the difference is stored into the performance difference vector;
T642, for all the second objective parameters within the updated container, the kernel function is adopted to calculate the correlation between the behavior characteristics of any two controller parameters, and Gaussian white noise with a variance of 0.01 is added to obtain a covariance matrix K;
T643, for all the controller parameters within the behavior map, a covariance matrix k is obtained by adopting the kernel function to calculate the correlation of the behavior characteristics between all the control parameters within the behavior map and all the second objective parameters within the updated container;
T644, in the Gaussian process model, the mean is calculated as:

$${μ}_{i} = {p}_{undamaged \_ i} + {k}^{T} \cdot ( {K}^{- 1} \cdot {P}_{d i f f} ) ;$$

wherein, P_{undamaged_i} represents the first performance value of the i-th controller parameter;
the process for updating the variance is as follows:
T645, the updating calculation of the variance corresponding to the i-th controller parameter is as follows:

$${σ}_{i}^{2} = M ( B {C}_{i} , {BC}_{i} ) - {k}^{T} \cdot {K}^{- 1} \cdot k ;$$

that is, an autocorrelation metric of the behavior characteristic BCᵢ minus the dot product of each covariance matrices.

The kernel function used in this solution is a Matern kernel function, which is used to calculate a similarity between two points and further utilized to establish a covariance matrix. This covariance matrix represents the correlations of performance values among all input behavior characteristics.

The Gaussian process model enhances the predictive capability by establishing correlations between the known behavior characteristic and performance value pairs (BC, P). This enables the model to extrapolate the performance values of new, untested controller parameters in the damaged environments based on the insights gained from tested parameters. This predictive modeling not only delivers high accuracy, but also outperforms exhaustive mapping of all controller parameters interactions with the damaged environment in both efficiency and speed. By focusing on leveraging the correlations through Gaussian process, it can significantly reduce the time to identity the optimal parameters, streamlining the exploration process in evolutionary computing frameworks.

In the initialization of variance, the kernel function calculates the autocorrelation for the behavior characteristic, indicating an initial estimate of predictive variability for this point. However, it is important to contextualize that this estimate will be further refined by considering the correlations with other points, aligning with the Gaussian process model's principle of leveraging inter-point relationships to enhance prediction accuracy.

T65, steps T63 and T64 are repeatedly executed until a preset second iteration stop condition is met; and
T66, the controller parameter with the maximum estimated performance is selected as a third objective parameter; both the first objective parameter and the third objective parameter are interacted with the damaged environment to obtain an evaluation result, and the one with the maximum second performance value is selected as the optimal controller parameter.

The equal-weight overall fitness value is the sum of the distance fitness value and the cost fitness value under the condition of equal weights.

In the map-based Bayesian optimization algorithm, the behavior characteristics and first performance values of all the controller parameters are used as a kind of prior knowledge to help the algorithm explore a parameter space more effectively. By combining the specific structure and characteristics of the map, the algorithm can more accurately predict the performance of the second performance value under different parameter configurations.

Gaussian Process (GP) is a type of stochastic process in probability theory and mathematical statistics, referring to a collection of random variables where any finite number of the random variables in this collection follow a joint normal distribution. In the Gaussian Process, any linear combination of the random variables follows a normal distribution, and every finite-dimensional distribution is the joint normal distribution, whose probability density function over a continuous index set is a Gaussian measure of all the random variables. The Gaussian Process is fully determined by its mathematical expectation and covariance function, inherits many properties of the normal distribution, and offers precise models for predicting performance landscapes of complex systems under optimization.

T61 is used to simulate a specific damaged environment;

In T65, the second iteration stop condition can be that the number of iterations reaches a preset objective total number of times.

By repeatedly executing T61 to T66, all the damaged environments can be simulated, thereby identifying the optimal controller parameter tailored to each unique damaged environment. The optimal controller parameter enables the robot to walk forward with better performance while incurring lower costs in the damaged environment, also meaning that for a specific scenario or environment, the obtained controller parameter can allow the robot to walk forward a longer distance with the lower costs, or to walk forward as far as possible without consuming excessive costs.

In real environments, parameter training requires using the controller parameters to control the robot to completely execute the entire operation process, which involves traversing a plurality of the damaged environments and a plurality of the controller parameters, leading to significant time consumption. In this solution, by simulating the process and updating the Gaussian process model, it is possible to predict the estimated performance corresponding to each controller parameter. Although traversing is still necessary, it is only used to calculate the correlations between the behavior characteristics, thereby updating the Gaussian process model. This eliminates the need to test all the controller parameters in the environment one by one, resulting in significantly shorter time consumption compared to traversing all the controller parameters in a single damaged environment.

While it is possible to directly select the first objective parameter as the optimal controller parameter, this approach may yield inferior results. A more effective method might involve a careful comparison of the first and the third objective parameter, leading to the selection of the third objective parameter as the optimal one. The direct selection method, however, has the advantage of saving computation time for the third objective parameter, essentially trading off quality for time.

T7, step T6 is repeated until all the damaged environments are simulated.

The behavior map construction phase corresponds to simulating the robot's undamaged environment, while the damage adaptation phase corresponds to simulating the damaged environment, i.e., the tested environment.

The distance fitness value is used to evaluate the distance traveled by the robot as it moves forward, such as the distance traveled forward in the x-axis direction after controlling the robot to perform an action. The cost fitness value is used to evaluate the cost incurred during movement, specifically the torque cost of each joint of the robot. For example, the cost fitness can be half of the sum of squares of the performed action vectors, and the action vector typically includes torques of all the joints.

The behavior characteristic refers to a characteristic that describe an individual's behavior or performance, and is often used to measure effectiveness or performance of the individual in solving a problem or executing a task. Any indicator or attribute that helps define the individual's behavior or performance can be considered the behavior characteristic. MAP-Elites is a quality-diversity optimization framework in the field of evolutionary computation. Its core idea is to maintain a finite set of cells, each of which preserves the optimal individual in that region of the behavior space, also known as an elite individual, thereby achieving simultaneous optimization of the quality and diversity. MAP-Elites maps a simulated robot's “state-action” trajectory onto the behavior map in the environment by defining the behavior characteristic. Consequently, based on the behavior characteristic, the individual possessing those behavior characteristics can be located within a specific grid in the behavior map.

In this disclosure, the damage recovery refers to a capability of controlling the robot to maintain its forward-moving form, even if one or several of its joints are damaged, by utilizing a certain controller parameter. This allows the robot to continue moving forward even in the face of an unexpected damage.

By decomposing an original single objective into two fitness functions, it enables the simultaneous processing of two objectives, avoiding the algorithm from falling into local optima and promoting the exploration of diversity in the solution space by the search algorithm, thus discovering a wider range of solutions. Ultimately, for the specific damaged environment, the most suitable optimal controller parameter is screened out from the behavior map as the optimal solution.

Compared to existing technologies, this solution does not require training a model based on different and real damaged environments to obtain one controller parameter that can control the robot to move forward in that specific damaged environment. Instead, it utilizes one single behavior map to construct the array of the controller parameters that can adapt to various damaged environments.

According to the disclosure and teachings of the above description, those skilled in the art to which the present disclosure belongs can also make changes and modifications to the above-described embodiments. Accordingly, the present disclosure is not limited to the specific embodiments disclosed and described above, and some modifications and variations of the present disclosure should also fall within the scope of the claims of the present disclosure. In addition, although some specific terms are used in the present specification, these terms are for convenience of explanation only and do not limit the present disclosure in any way.

1. A method for robot damage recovery based on multi-objective MAP-Elites, the robot being a multi-legged robot, wherein the method comprises a behavior map construction phase and a damage adaptation phase, which respectively correspond to an undamaged environment and a damaged environment of the robot, both the undamaged environment and the damaged environment are simulated environments, and there is at least one damaged environment;
the behavior map construction phase comprises the following steps:
T1, initializing a behavior map, the behavior map comprising a plurality of grids, with at least one grid storing one controller parameter;
T2, picking one of the controller parameters from the behavior map as a parent controller parameter; obtaining a plurality of sample controller parameters by sampling around the parent controller parameter; interacting each of these sample controller parameters with the undamaged environment, respectively, and obtaining an evaluation result by evaluating the interaction, the evaluation result comprising a behavior characteristic, a distance fitness value, and a cost fitness value; obtaining gradient direction information by calculating an evolutionary gradient based on the evaluation result;
wherein, the ‘interaction’ specifically refers to controlling the robot to execute an episode in the simulated environment, which consists of a sequence of steps facilitated by application of the controller parameter;
T3, obtaining a child controller parameter by evolving the parent controller parameter according to the gradient direction information; obtaining an evaluation result by interacting the child controller parameter with the undamaged environment, and identifying an objective grid by locating a position of the child controller parameter within the behavior map based on the behavior characteristic;
T4, comparing a dominance relationship between all the controller parameters within the objective grid and the child controller parameter according to the distance fitness value and the cost fitness value;
according to the dominance relationship, storing the child controller parameter to the objective grid, or replacing the controller parameter within the objective grid, or discarding the child controller parameter; and
T5, repeatedly executing steps T2 to T4 until a preset first iteration stop condition is reached;
the damage adaptation phase comprises the following steps:
T6, selecting one damaged environment, initializing a damage recovery model using a map-based Bayesian optimization algorithm and the behavior map; obtaining an optimal controller parameter by adjusting and searching the damage recovery model; causing the multi-legged robot to recover in the damaged environment by using the optimal controller parameter; and
T7, repeating step T6 until all the damaged environments are simulated.

2. The method for robot damage recovery based on multi-objective MAP-Elites according to claim 1, wherein T1 comprises the following specific steps:
T11, initializing a behavior space, which has a storage capacity to store Num controller parameters; converting the behavior space into the behavior map with the plurality of grids according to a preset discrete value Dis; and
T12, obtaining the controller parameters by randomly initializing a neural network model parameters based on a fully connected neural network; controlling the robot to interact with the undamaged environment by using the controller parameters and obtaining an evaluation result by evaluating the interaction; locating the controller parameters according to the behavior characteristic and storing them in the grids.

3. The method for robot damage recovery based on multi-objective MAP-Elites according to claim 2, wherein, in T11, a preset dimension value Dim is also comprised, wherein the behavior space is uniformly discretized into Dis parts along each dimension according to the discrete value Dis to obtain the behavior map whose number of the grids is Dis^{Dim}; the number of the controller parameters that each of the grids accommodates is
$$\frac{N u m}{D i {s}^{D i m}} .$$

4. The method for robot damage recovery based on multi-objective MAP-Elites according to claim 1, wherein the behavior characteristic is a multi-dimensional vector, each dimension of this vector represents the proportion of time that a given foot of the robot is in contact with the ground during each episode of steps, with a value ranging from 0 to 1;
each of the grids corresponds to a unique first identifier, the first identifier is a multi-dimensional array or a multi-dimensional vector and comprises a plurality of index values; and
dimensions of the behavior map, the behavior characteristic, and the first identifier are the same; the locating process is performed by dividing the value range into a plurality of intervals according to the dimension, and mapping and converting each parameter of the behavior characteristic into the index value based on its sequential position according to the intervals, thereby obtaining the corresponding first identifier.

5. The method for robot damage recovery based on multi-objective MAP-Elites according to claim 1, wherein T2 comprises the following specific steps:
T21, in the behavior map, taking a sum of the distance fitness value and the cost fitness value as an equal-weight overall fitness value; selecting the grid where the controller parameter with the maximum equal-weight overall fitness value is located; or
for the most recent a grids where the controller parameters have been stored, ranking in a descending order based on the equal-weight overall fitness value, randomly selecting one of the top b grids, wherein a and b are predefined integer values, and a≥b;
T22, randomly selecting one of the controller parameters from the selected grid as the parent controller parameter;
T23, constructing an isotropic multivariate Gaussian distribution based on the parent controller parameter, generating the plurality of sample controller parameters by randomly sampling in the multivariate Gaussian distribution;
T24, controlling the robot to interact with the undamaged environment using the sample controller parameters and obtaining the evaluation result by performing evaluation; and
T25, assigning different weights to the distance fitness value and the cost fitness value of the sample controller parameter, respectively, calculating a weighted overall fitness value; obtaining the gradient direction information by performing gradient estimation on the weighted overall fitness value using a stochastic gradient ascent method.

6. The method for robot damage recovery based on multi-objective MAP-Elites according to claim 5, wherein the distance fitness value, the cost fitness value and the weighted overall fitness value are represented by D(θ), C(θ) and F(θ), respectively; the corresponding weights for the distance fitness value and the cost fitness value are ∝, and β, respectively;
in each iteration, the process of calculating the weighted overall fitness value is as follows:
$$∝ = ∝ - \frac{2 \times w - R}{N} ,$$
$$β = 1 - ∝ ,$$
$$F ( θ ) = ∝ D ( θ ) + β C ( θ ) ;$$
wherein, R is a weight range control parameter; w is a distance function initial weight, the weight range corresponding to the distance fitness value is [R-w, w]; N is the number of iterations, θ is the controller parameter.

7. The method for robot damage recovery based on multi-objective MAP-Elites according to claim 1, wherein, in T4, the dominance relationship comprises a completely dominating relationship, a completely dominated relationship, and a non-dominance relationship;
in response to determining that the child controller parameter outperforms one or more controller parameters within the objective grid in terms of both the distance fitness value and the cost fitness value, this situation is classified as the completely dominating relationship; in this case, all the controller parameters within the objective grid that are fully dominated by the child controller parameter are removed, and the child controller parameter is stored in the objective grid;
in response to determining that at least one controller parameter within the objective grid completely dominates the child controller parameter, it is considered as the completely dominated relationship, and the child controller parameter is discarded; and
in response to determining that the dominance relationship between the child controller parameter and the controller parameters within the objective grid is neither the completely dominating relationship nor the completely dominated relationship, it is considered as the non-dominance relationship; in this case, it is judged whether a storage space of the objective grid has reached the maximum capacity: if not, the child controller parameter is directly stored in the objective grid; otherwise, one controller parameter within the objective grid is randomly selected and replaced with the child controller parameter.

8. The method for robot damage recovery based on multi-objective MAP-Elites according to claim 1, wherein each leg of the multi-legged robot comprises at least two joints, which are in either a damaged or normal state;
in T6, for the controller parameter, a performance value is obtained by adding a product of the distance fitness value with a custom weight and a product of the cost fitness value with another custom weight; wherein the performance values calculated for the controller parameter after interacting with the undamaged environment and the damaged environment are respectively a first performance value and a second performance value;
T6 comprises the following specific steps:
T61, setting an arbitrary number of the joints at arbitrary positions to the damaged state to simulate the damaged environment;
T62, in the behavior map, calculating the first performance values for all the controller parameters, wherein the controller parameter with the maximum first performance value is the first objective parameter;
constructing a Gaussian process model by adopting the map-based Bayesian optimization algorithm and using the behavior characteristics and the first performance values of all the controller parameters from the behavior map, wherein the Gaussian process model is used to predict the performance of the controller parameters; the Gaussian process model is structured as a dictionary: its keys are unique second identifiers corresponding one-to-one with the controller parameters within the behavior map; the value of the dictionary is a tuple consisting of a mean μ and a variance σ², wherein the mean represents an estimated performance of the controller parameter;
T63, constructing an acquisition function by utilizing the mean and variance; calculating a function value for the controller parameter using the acquisition function and selecting the controller parameter with the maximum function value as a second objective parameter;
T64, obtaining an evaluation result by interacting the second objective parameter with the damaged environment; updating the Gaussian process model by using the characteristic and the second performance value of the second objective parameter;
T65, repeating steps T63 and T64 until a preset second iteration stop condition is met; and
T66, selecting the controller parameter with the maximum estimated performance as a third objective parameter; obtaining an evaluation result by interacting both the first objective parameter and the third objective parameter with the damaged environment, and selecting the one with the maximum second performance value as the optimal controller parameter.

9. The method for robot damage recovery based on multi-objective MAP-Elites according to claim 8, wherein, in T61, an updated container is also constructed;
in T63, the second objective parameter is also stored in the updated container;
in T62, mean and variance initialization is performed for all the controller parameters within the behavior map;
wherein, the first performance value of each controller parameter is normalized, the first performance value is converted to a decimal value within the range of [0,1], which serves as an initial value of the mean;
an initial value of the variance is calculated as:
$${σ}_{i}^{2} = M ( B {C}_{i} , {BC}_{i} ) ;$$
wherein, i is the second identifier, representing the i-th controller parameter within the behavior map; BCᵢ represents the characteristic of the i-th controller parameter; M(x,y) is a kernel function, and the construction formula of the kernel function is:
$$M ( x , y ) = ( 1 + \frac{\sqrt{5} d}{v} + \frac{5 {d}^{2}}{3 {v}^{2}} ) \times exp ( - \frac{\sqrt{5} d}{v} ) ;$$
wherein, x and y represent two behavior characteristics, d represents an Euclidean distance between x and y, and v is a preset length scale parameter;
$$exp ( - \frac{\sqrt{5} d}{v} )$$
is an exponential function, representing e raised to the power of
$$- \frac{\sqrt{5} d}{v} ;$$
the kernel function is used to calculate the correlation between two behavior characteristics;
in T64, all the means and variances of the Gaussian process model are updated;
wherein, the process for updating the means is as follows:
T641, constructing a performance difference vector P_{diff}; for all the second objective parameters in the updated container, calculating a difference of the first performance value and second performance value of each second objective parameter, and storing the difference into the performance difference vector;
T642, for all the second objective parameters within the updated container, calculating the correlation between the behavior characteristics of any two controller parameters by adopting the kernel function, and obtaining a covariance matrix K after adding Gaussian white noise with a variance of 0.01;
T643, for all the controller parameters within the behavior map, obtaining a covariance matrix k by adopting the kernel function to calculate the correlation of the behavior characteristics between all the controller parameters within the behavior map and all the second objective parameters within the updated container;
T644, in the Gaussian process model, updating the mean according to the following formula:
$${μ}_{i} = {p}_{undamaged \_ i} + {k}^{T} \cdot ( {K}^{- 1} \cdot {P}_{d i f f} ) ;$$
wherein, P_{undamaged_i} represents the first performance value of the i-th controller parameter;
the process for updating the variance is as follows:
T645, updating the variance corresponding to the i-th controller parameter according to the following formula:
$${σ}_{i}^{2} = M ( B {C}_{i} , {BC}_{i} ) - {k}^{T} \cdot {K}^{- 1} \cdot k ;$$
that is, an autocorrelation metric of the behavior characteristic BCᵢ minus the dot product of each covariance matrices.

10. The method for robot damage recovery based on multi-objective MAP-Elites according to claim 8, wherein the acquisition function is expressed as
$$UC {B}_{i} = {μ}_{i} + κ {σ}_{i}^{2} ,$$
wherein κ is an exploration parameter, and i is the second identifier.
